(19) United States
(12) Patent Application Publication
(10) Pub. No.: US 2012/0098740 A1
(43) Pub. Date: Apr. 26, 2012

(54) ELECTRO-PHORETIC DISPLAY APPARATUS

(75) Inventors: Wen-Pin Chiu, Taoyuan County (TW); Chun-An Wei, New Taipei City (TW); Ping-Yueh Cheng, Taoyuan County (TW); Feng-Shou Lin, Tainan City (TW)

(73) Assignee: SIPIX TECHNOLOGY INC., Taoyuan County (TW)

(21) Appl. No.: 13/225,475

(22) Filed: Sep. 4, 2011

(30) Foreign Application Priority Data
Oct. 20, 2010 (TW) 99135779

(51) Int. Cl. G09G 3/34

(52) U.S. Cl. 345/107

(57) ABSTRACT

An electro-phoretic display apparatus is disclosed. The electro-phoretic display apparatus has a plurality of pixel units and is coupled to an alternating current (AC) common voltage. The electro-phoretic display apparatus includes a switching unit coupled between a path of a plurality of storage capacitors in the pixel units and the common voltage. The switching unit is turned off according to a control signal before the common voltage carries out a transition action. The switching unit is turned on according to the control signal after the common voltage carries out the transition action.

### CROSS-REFERENCE TO RELATED APPLICATION

This application claims the priority benefit of Taiwan application serial no. 99135779, filed on Oct. 20, 2010. The entirety of the above-mentioned patent application is hereby incorporated by reference herein and made a part of this specification.

### BACKGROUND OF THE INVENTION

1. Field of the Invention

The invention generally relates to an electro-phoretic display apparatus.

2. Description of Related Art

With the increasing advancements in electronic technologies nowadays, the electronic paper has emerged as a next generational product popular for enabling a user to have a convenient reading experience. By using electronic paper technology, people no longer have to carry heavy and voluminous books or magazines in order to peruse a large quantity of information. Among the electronic paper technologies, the electro-phoretic display apparatus is a common and popular implementation.

Please refer to FIG. 1, which schematically illustrates a conventional electro-phoretic display apparatus 100. The electro-phoretic display apparatus 100 includes a plurality of pixel units 110-140, and the pixel units are arranged in an array between the scan lines GL1-GL4 and the data lines DL1-DL5. The scan lines GL1-GL4 and the data lines DL1-DL5 are arranged perpendicular to each other. In addition to being coupled to the corresponding scan lines and data lines, the pixel units 110-140 receive an alternating current (AC) common voltage VCOM. On a panel layout of the conventional electro-phoretic display apparatus 100 where the pixel units 110 and 120 are coupled to the first scan line GL1, only the common voltage VCOM correspondingly coupled to the pixel units 110 and 120 is directly coupled to a power source device (not drawn) providing the common voltage VCOM. On the other hand, the pixel units 130-140 coupled to other scan lines GL2 and GL4 are coupled with the power source device through a transparent conductive film (e.g., an indium tin oxide (ITO) film) from a farther distance. Accordingly, timing delays exist between the common voltage VCOM coupled to the pixel units on each of the scan lines.

Please refer to FIG. 2, which illustrates a relational diagram of a pixel voltage of a pixel unit and the common voltage of the conventional electro-phoretic display apparatus. The pixel voltage on the pixel units of the first line Linel is synchronous with the common voltage VCOM, and the pixel voltage on the pixel units of the last line LineN has a timing delay with the common voltage VCOM, such as the timing delay shown in a region D1 (when the display image remains the same). Moreover, since a turn on time tON and a turn off time tOFF for the electro-phoretic display apparatus are not the same, after successive appearances of the timing differences in the region D1, an image fading phenomenon is generated.

### SUMMARY OF THE INVENTION

Accordingly, the invention is directed to two electro-phoretic display apparatuses for mitigating the image fading phenomenon generated by a transition of an alternating current (AC) common voltage.

The invention is directed to an electro-phoretic display apparatus having a plurality of pixel units. The pixel units are jointly coupled to the AC common voltage. The electro-phoretic display apparatus includes a switching unit coupled between a path of a storage capacitor in the pixel units and the common voltage. The switching unit is turned off according to a control signal before the common voltage carries out a transition action, and the switching unit is turned on according to the control signal after the common voltage carries out the transition action.

According to an embodiment of the invention, the electro-phoretic display apparatus further includes a control signal generator. The control signal generator is coupled to the switching unit for detecting a time point when the common voltage carries out the transition action, and generating the control signal according to the time point.

According to an embodiment of the invention, when the common voltage carries out the transition action, a voltage level of the common voltage transitions from a first voltage level to a second voltage level, or the voltage level of the common voltage transitions from the second voltage level to the first voltage level, in which the first voltage level is higher than the second voltage level.

According to an embodiment of the invention, when the switching unit is turned off, a pixel voltage received by each of the pixel units transitions synchronously with the common voltage.

According to an embodiment of the invention, the switching unit is a transistor switch.

The invention is directed to an electro-phoretic display apparatus having a plurality of display regions, each of the display regions having at least one pixel unit, and the display regions receive a plurality of common voltages. The electro-phoretic display apparatus includes a plurality of switching units, each of the switching units respectively coupled to a path in which a storage capacitor in all of the pixel units in each of the display regions receives each of the corresponding common voltages. Each of the corresponding switching units is turned off according to a control signal before each of the common voltages carries out a transition action, and each of the corresponding switching units is turned on according to the control signal after each of the common voltages carries out the transition action.

In summary, according to an embodiment of the invention, the path of the storage capacitors in the pixel units receiving the common voltage is disconnected before the AC common voltage transitions. Moreover, the path of the storage capacitors in the pixel units and the common voltage is reconnected after the common voltage transitions, so as to mitigate the image fading phenomenon between the pixel units generated by the asynchronous transition time points of the pixel voltages received by the pixel units, and thereby enhance the image quality of the electro-phoretic display apparatus.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional electro-phoretic display apparatus.

FIG. 2 is a relational diagram of a pixel voltage of a pixel unit and a common voltage of the conventional electro-phoretic display apparatus.

FIG. 3 is a schematic view of an electro-phoretic display apparatus according to an embodiment of the invention.

FIGS. 3A-3C sequentially illustrates an operational relationship of a pixel unit and a switching unit according to an embodiment of the invention.

FIG. 4 is a operational waveform diagram of an electro-phoretic display apparatus according to an embodiment of the invention.

FIG. 5 is a schematic view of an electro-phoretic display apparatus according to another embodiment of the invention.

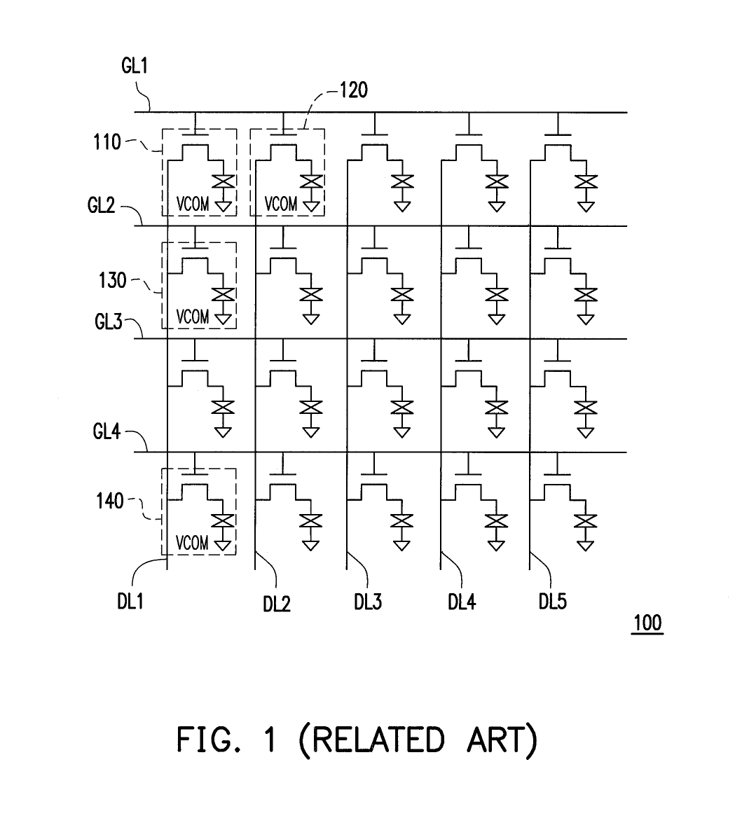

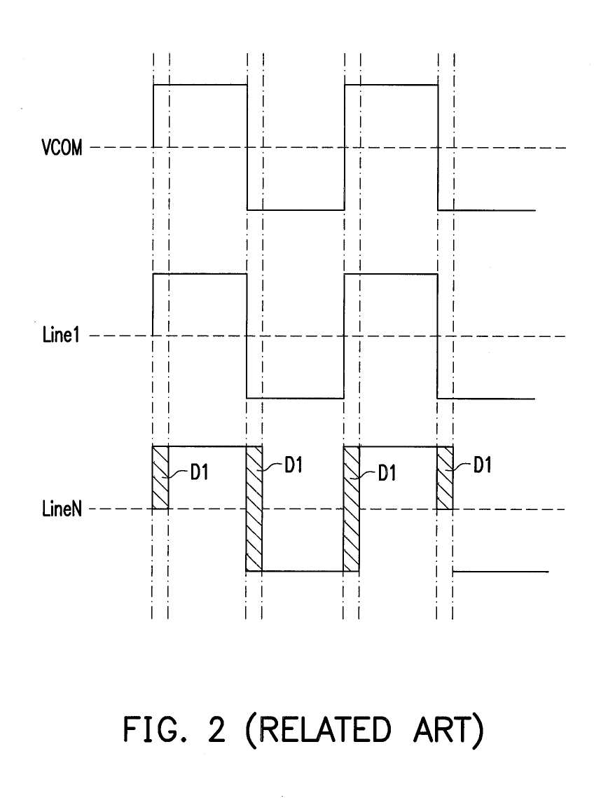

### DESCRIPTION OF EMBODIMENTS

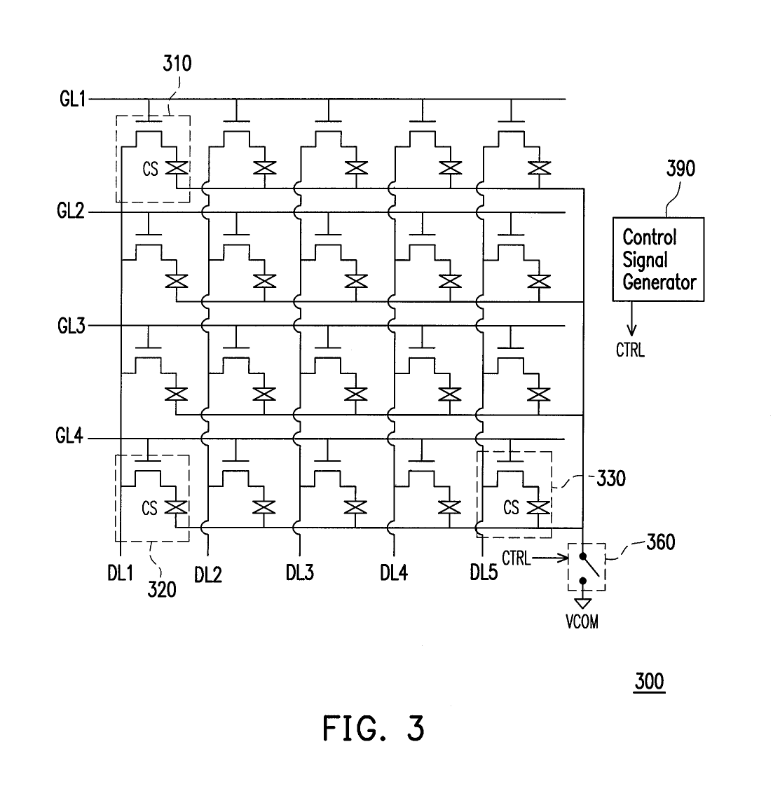

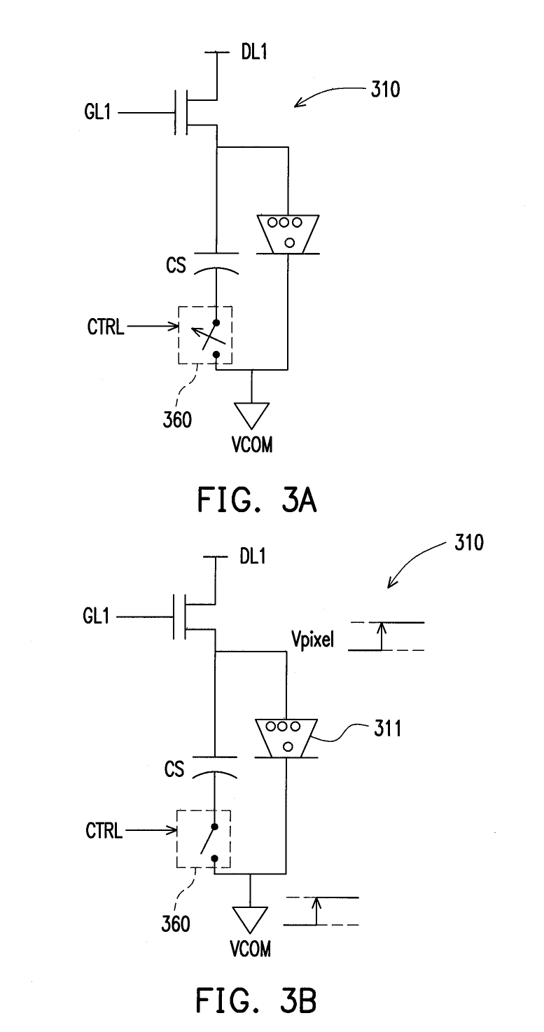

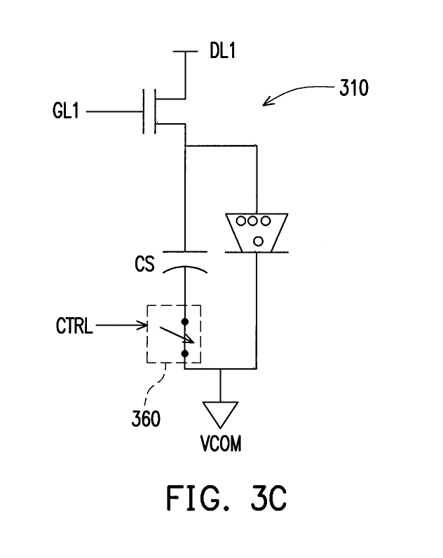

Please refer to FIG. 3, FIG. 3 illustrates a schematic view of an electro-phoretic display apparatus 300 according to an embodiment of the invention. The electro-phoretic display apparatus 300 includes a plurality of pixel units 310-330 jointly coupled to an alternating current (AC) common voltage VCOM. In addition, the pixel units 310-330 are arranged in an array between the scan lines GL1-GL4 and the data lines DL1-DL5. Moreover, a switching unit 360 is serially coupled between a path of a storage capacitor CS in the pixel units 310-330 coupled to and receiving the common voltage VCOM.

Further, a control signal CTRL controls whether the switching unit 360 is turned on or off. The control signal CTRL changes according to a transition of the common voltage VCOM. Referring to both FIGS. 3 and 3A-3C, FIGS. 3A-3C sequentially illustrates an operational relationship of the pixel unit 310 and the switching unit 360 according to an embodiment of the invention. The pixel unit 310 is used hereafter as an example for elaboration. Referring first to FIG. 3A, before the common voltage VCOM transitions and right before the common voltage VCOM transitions, the switching unit 360 is turned off according to the control signal CTRL.

Thereafter, referring to FIG. 3B, when the switching unit 360 is turned off and the turned off state is maintained, the common voltage VCOM performs a transition action. It should be noted that, in the illustration depicted in FIG. 3B, the common voltage VCOM transitions from a low first voltage to a high second voltage. However, this transition action is merely an illustrative example, since the AC common voltage VCOM not only can transition from the low first voltage to the high second voltage, but can also transition from the high second voltage to the low first voltage. At the same time, due to a coupling phenomenon generated by a display capacitor 311, a pixel voltage Vpixel applied on the pixel unit 310 carries out the same transition action corresponding to the transition of the common voltage VCOM. Moreover, the display capacitor 311 is a parasitic capacitor generated by the structure of the pixel unit 310.

Next, referring to FIG. 3C, after the common voltage VCOM completes the transition action, the switching unit 360 is turned on again according to the control voltage CTRL, and the storage capacitor CS is reconnected with the common voltage VCOM.

From the above description, it should be apparent that the operation of the control signal CTRL is controlled by a transition time point of the common voltage VCOM. Moreover, persons having ordinary knowledge in the art should appreciate that the transition time point of the common voltage VCOM may be calculated by a timing signal generator (not drawn), which generates driving signals in the electro-phoretic display apparatus 300. Therefore, the control signal CTRL may be generated by a control signal generator 390 depicted in FIG. 3. The control signal generator 390 may obtain information on the transition time point of the common voltage VCOM from the timing signal generator, and accordingly generate the control signal CTRL. Moreover, the control signal generator 390 may be built in the timing signal generator, or may be independently configured and external to the timing signal generator.

It should be noted that the switching unit 360 may be a transistor switch formed by thin film transistors.

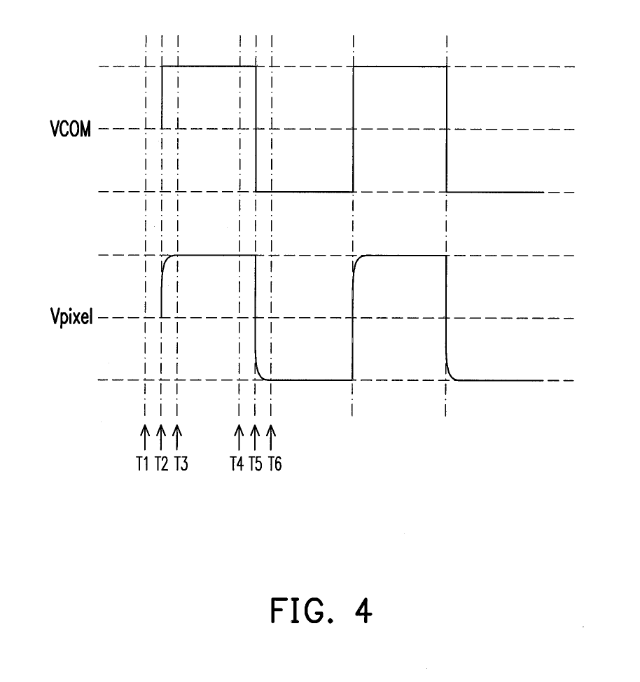

Please refer to FIG. 4, which is a operational waveform diagram of the electro-phoretic display apparatus 300 according to an embodiment of the invention. At a time point T1, the switching unit 360 is turned off from the turned on state before the common voltage VCOM carries out the transition action. At a time point T2, the common voltage VCOM carries out the transition action (from low to high voltage level), the switching unit 360 is maintained at the turned off state, and the pixel voltage Vpixel and the common voltage VCOM synchronously carry out the transition action (from low to high voltage level). Thereafter, at a time point T3, the switching unit 360 at the turned off state is turned on, so the storage capacitor of the pixel unit is reconnected with the common voltage VCOM. Moreover, at a time point T4 before the next transition action of the common voltage VCOM, the switching unit 360 is again turned off from the turned on state. At a time point T5, the common voltage VCOM carries out the transition action (from high to low voltage level), the switching unit 360 is maintained at the turned off state, and the pixel voltage Vpixel and the common voltage VCOM synchronously carry out the transition action (from high to low voltage level). Thereafter, at a time point T6, the switching unit 360 is turned on from the turned off state, so the storage capacitor of the pixel unit is reconnected with the common voltage VCOM.

Accordingly, in the present embodiment of the invention, a largest possible time delay generated between the pixel units on each line of the electro-phoretic display apparatus 300 can be calculated. According to a range of this largest possible time delay, the time points for turning off and on the switching unit 360 may be set, so as to effectively synchronize the transition actions of the pixel voltage Vpixel and the common voltage VCOM, and thereby mitigate an image fading phenomenon.

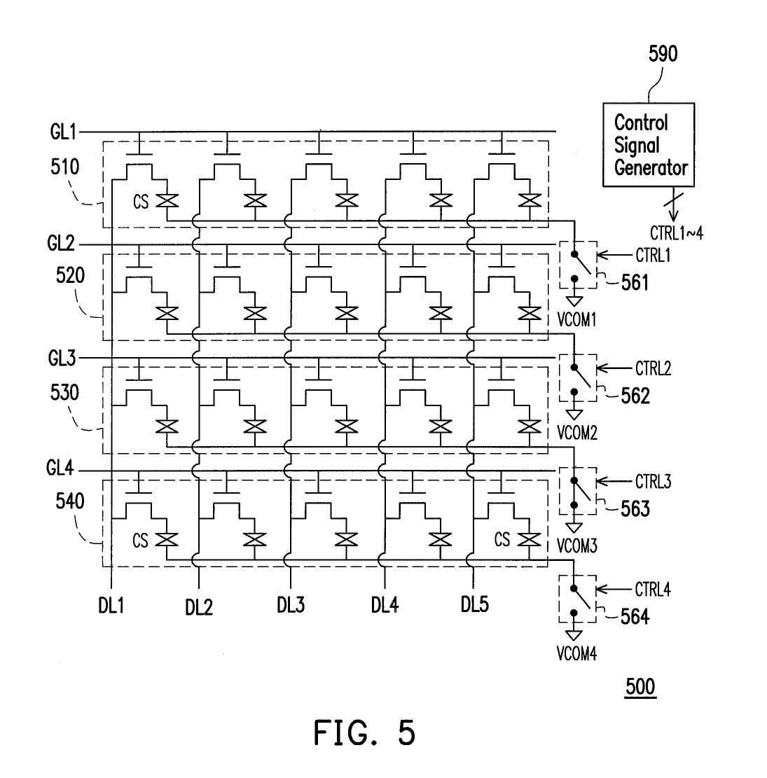

Please refer to FIG. 5, which is a schematic view of an electro-phoretic display apparatus 500 according to another embodiment of the invention. The electro-phoretic display apparatus 500 includes a plurality of pixel units, and the pixel units are divided into a plurality of display regions 510-540, with each of the display regions including at least one pixel unit. The electro-phoretic display apparatus 500 also includes a plurality of switching units 561-564. Each of the switching units 561-564 is respectively coupled to a path in which each of the display regions 510-540 receives each of the corresponding common voltages VCOM1-VCOM4. Before each of the common voltages VCOM1-VCOM4 carries out the transition action, each of the corresponding switching units 561-564 is turned off according to the control signals CTRL1-CTRL4. Moreover, after each of the common voltages VCOM1-VCOM4 carries out the transition action, each of the corresponding switching units 561-564 is turned on according to the control signals CTRL1-CTRL4.

Further, the control signals CTRL1-CTRL4 are generated by a control signal generator 590 coupled to the switching units 561-564. The configuration of the control signal generator 590 has been described in detail in a previous embodiment, and therefore further elaboration thereof is omitted hereafter. However, a difference compared to the previous embodiment is that, in the present embodiment, the control signal generator 590 may generate different control signals CTRL1-CTRL4 according to common voltages VCOM1-VCOM4 of each different transition time point. Accordingly, at different time points, the switching operations of the switching units 561-564 points may be carried out on pixel units of different lines, so as to improve the accuracy of the overall operation.

Moreover, the display region configuration of the pixel units does not necessarily have to be divided in rows as depicted in FIG. 5. The display regions may also be arranged according to the columns of the pixel units, or divided into odd or even columns or rows. According to a practical requirement, a designer may arrange pixel units of different configurations into a display region, and the storage capacitors of all the pixel units in a same display region employ the same switching unit for coupling to the common voltage VCOM.

In view of the foregoing, according to an embodiment of the invention, a coupling path of the storage capacitors in the pixel units and the common voltage is disconnected before the AC common voltage transitions. Moreover, the common voltage carries out the transition action under the condition of the disconnected path described above. Accordingly, the pixel voltage and the common voltage carry out the transition action synchronously, so as to mitigate the asynchronous effect generated by the delay of the pixel units on different lines in receiving the common voltage. In other words, the image fading phenomenon generated by the asynchronous effect can be effectively mitigated.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electro-phoretic display apparatus having a plurality of pixel units, the pixel units jointly coupled to an alternating current (AC) common voltage, the electro-phoretic display apparatus comprising:
a switching unit coupled between a path of a storage capacitor in the pixel units and the common voltage, the switching unit is turned off according to a control signal before the common voltage carries out a transition action, and the switching unit is turned on according to the control signal after the common voltage carries out the transition action.

2. The electro-phoretic display apparatus as claimed in claim 1, further comprising:
a control signal generator coupled to the switching unit for detecting a time point when the common voltage carries out the transition action, and generating the control signal according to the time point.

3. The electro-phoretic display apparatus as claimed in claim 1, wherein when the common voltage carries out the transition action, a voltage level of the common voltage transitions from a first voltage level to a second voltage level, or the voltage level of the common voltage transitions from the second voltage level to the first voltage level, wherein the first voltage level is higher than the second voltage level.

4. The electro-phoretic display apparatus as claimed in claim 1, wherein when the switching unit is turned off, a pixel voltage received by each of the pixel units transitions synchronously with the common voltage.

5. The electro-phoretic display apparatus as claimed in claim 1, wherein the switching unit is a transistor switch.

6. An electro-phoretic display apparatus having a plurality of display regions, each of the display regions having at least one pixel unit, and the display regions receiving a plurality of common voltages, the electro-phoretic display apparatus comprising:
a plurality of switching units, each of the switching units respectively coupled to a path wherein a storage capacitor in all of the pixel units in each of the display regions receives each of the corresponding common voltages, each of the corresponding switching units is turned off according to a control signal before each of the common voltages carries out a transition action, and each of the corresponding switching units is turned on according to the control signal after each of the common voltages carries out the transition action.

7. The electro-phoretic display apparatus as claimed in claim 6, further comprising:
a control signal generator coupled to the switching units for detecting a time point when each of the common voltages carries out the transition action, and generating the corresponding control signal according to the time point.

8. The electro-phoretic display apparatus as claimed in claim 6, wherein when each of the common voltages carries out the transition action, a voltage level of each of the common voltages transitions from a first voltage level to a second voltage level, or the voltage level of each of the common voltages transitions from the second voltage level to the first voltage level, wherein the first voltage level is higher than the second voltage level.

9. The electro-phoretic display apparatus as claimed in claim 6, wherein when each of the switching units is turned off, a pixel voltage received by each of the corresponding pixel units transitions synchronously with each of the common voltages.

10. The electro-phoretic display apparatus as claimed in claim 6, wherein each of the switching units is a transistor switch.
